(19) United States
(12) Patent Application Publication
(10) Pub. No.: US 2009/0237833 A1
(43) Pub. Date: Sep. 24, 2009

(54) MAGNETIC TAPE APPARATUS USING PERPENDICULAR MAGNETIC RECORDING

(75) Inventors: Hideaki SATO, Tokyo (JP); Naoki OHTA, Tokyo (JP); Hiraku HIRABAYASHI, Tokyo (JP); Nozomu HACHISUKA, Tokyo (JP); Noriaki KASAHARA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/051,496

(22) Filed: Mar. 19, 2008

(51) Int. Cl. G11B 21/02

(52) U.S. Cl. 360/77.12

(57) ABSTRACT

Provided is a magnetic tape apparatus using perpendicular magnetic recording, which has the function corresponding to an soft-magnetic under layer with sufficiently large thickness and enables the magnetic tape to maintain life sufficiently. This magnetic tape apparatus comprises: a tape head comprising at least one write head element for perpendicular magnetic recording; and a soft-magnetic capstan belt having a surface contact with the magnetic tape and pressing the magnetic tape to the tape head at least during recording, for controlling running speed of the magnetic tape by causing the magnetic tape to run together with the soft-magnetic capstan belt. Further it is preferable that at least two capstan-belt axes are further provided, and the soft-magnetic capstan belt is a loop running among the at least two capstan-belt axes.

### BACKGROUND OF THE INVENTION

1. Field of the Invention

The present invention relates to a magnetic tape apparatus for recording data to the magnetic tape, especially to a magnetic tape apparatus for recording by perpendicular magnetic recording technology.

2. Description of the Related Art

In recent years, magnetic recording and reproducing apparatuses have been remarkably improved in capacity of storage data, corresponding to the widespread use of multimedia and the Internet. And magnetic tape apparatuses for backing up or storing data or for recording and reproducing audio video information and so on are no exception of this trend of larger capacity. They have been required to be improved in areal recording density corresponding to the larger capacity.

To achieve the higher recording density, perpendicular magnetic recording has been adopted instead of conventional longitudinal magnetic recording, and actually contributes to the significant improvement in areal recording density. In the perpendicular magnetic recording, demagnetization field drastically decreases in the magnetization transition region between record bits formed on a magnetic recording medium; therefore, the magnetization transition width can become much smaller than that of the longitudinal magnetic recording. Furthermore, the record bits formed by the perpendicular magnetic recording are not greatly affected by thermal fluctuation that becomes serious problem for achieving higher recording density in the longitudinal magnetic recording. As described above, the perpendicular magnetic recording has a potential to realize more stable and higher recording density.

Currently, in the thin-film magnetic head for the perpendicular magnetic recording, a shielded pole structure is mainly adopted, which includes a main magnetic pole, an auxiliary magnetic pole as a return yoke, and a write coil for exciting magnetic flux in these magnetic poles. Whereas, the corresponding magnetic recording medium mainly has a stacked structure of: a perpendicular magnetization layer on which record tracks are formed; and a soft-magnetic under layer (SUL) for acting as a part of magnetic circuit in which magnetic flux starts from the main magnetic pole and is lead to the auxiliary magnetic pole through the perpendicular magnetization layer.

Further currently, the application of the perpendicular magnetic recording to magnetic tape apparatuses proceeds to improve recording densities of the apparatuses, as described in, for example, Japanese Patent Publication No. 59-019213A. Further, Japanese Patent Publication No. 2007-220179A discloses a technique, though not for perpendicular magnetic recording, in which DC erasing is performed by applying magnetic fields perpendicularly to the record layer of a magnetic tape. And Japanese Patent Publication No. 11-149635A describes a technique, also though not for perpendicular magnetic recording, in which recording is performed by irradiating light perpendicularly to a tape on which material for optical recording medium is applied.

When applying the perpendicular magnetic recording to magnetic tape apparatuses, there occurs a problem of setting the SUL. In fact, because a magnetic head for magnetic tapes (tape head) is greatly larger in size than a thin-film magnetic head for hard disks, the magnetic circuit of the tape head becomes a larger loop. Therefore, the thickness of the SUL for magnetic tapes, which acts as a part of the magnetic circuit, must be set to be one or more order of magnitude larger than that of the SUL for hard disks. Actually, in the thin-film magnetic head for hard disks, the space between the main magnetic pole and the auxiliary magnetic pole is of, for example, the order of 10 nm (nanometers) or the vicinity, whereas, the space in the tape head would be of, for example, the order of 0.1 μm (micrometer) or the vicinity. Therefore, the SUL for magnetic tapes must have a significantly larger thickness according to the difference between both spaces. However, the significantly larger thickness of the SUL would be likely to cause the decrease in recording density per volume in the form of a reel of magnetic tape, the degradation in flexibility of the magnetic tape which would lead an inadequate contact with the head, or the damage such as for the constituent film being peeled from the magnetic tape.

As an approach for resolving the problems about the SUL, Japanese Patent Publication No. 63-122001A describes a technique for the perpendicular magnetic recording, in which an auxiliary tape with SUL is provided in addition to a main tape with perpendicular magnetization layer, and recording is performed under the condition that the auxiliary tape is contacted with the main tape at the position of tape head. Further Japanese Patent Publication No. 63-122001A discloses an embodiment of helical-scanning cylinder heads. Helical-scanning cylinder heads are also disclosed in, for example, Japanese Patent Publication No. 09-154096A.

However, in Japanese Patent Publication No. 63-122001A, the auxiliary tape, as well as the main tape, is wound around reels; and especially in the case using a tape cartridge, both tapes must be stored within the tape cartridge. Therefore, it is significantly difficult to provide an SUL with a thickness sufficiently large for avoiding the above-described problems about the SUL.

Further, a magnetic tape for the perpendicular magnetic recording is set to have a markedly smaller thickness according to higher recording density. Therefore, there is a possibility that the magnetic tape would be stretched over time; and thus the magnetic tape would have a shorter lifetime. Generally, the running of the magnetic tape is regulated with reels and a capstan. The capstan governs the running speed of the magnetic tape. Then, a tensile stress is brought about in the magnetic tape by the capstan as well as the tape head. The tensile stress would be likely to cause the stretch of the thin magnetic tape to be enhanced. However, it is difficult to resolve this problem by using the above-described prior art.

### BRIEF SUMMARY OF THE INVENTION

Therefore, an object of the present invention is to provide a magnetic tape apparatus using perpendicular magnetic recording, which has the function corresponding to an SUL with sufficiently large thickness and enables the magnetic tape to maintain life sufficiently.

Before describing the present invention, terms used herein will be defined. In a structure of element(s) formed on/above an element formation surface of the substrate in a magnetic head part, one side closer to the substrate when viewed from a standard layer or element is referred to as being “lower” than, “beneath” or “below” the standard layer or element, and the opposite side is referred to as being “upper”, “on” or “above” the standard layer or element. Further, a portion on the substrate side of a layer or element is referred to as a “lower” portion, and a portion on the opposite side is referred to as an “upper” portion.

Furthermore, in some figures showing embodiments of magnetic tape apparatuses according to the present invention, X-axis direction, Y-axis direction and Z-axis direction are defined, according to need. Further, a surface having a loading slot for a tape cartridge is defined as a “front” surface, and the direction of the axis of a drive motor driving a real for a magnetic tape is defined as an upper-and-lower direction (a direction along Z-axis).

According to the present invention, provided is a magnetic tape apparatus for recording data to a magnetic tape with a perpendicular magnetization layer, which comprises: a tape head comprising at least one write head element for perpendicular magnetic recording; and a soft-magnetic capstan belt having a surface contact with the magnetic tape and pressing the magnetic tape to the tape head at least during recording, for controlling running speed of the magnetic tape by causing the magnetic tape to run together with the soft-magnetic capstan belt.

The soft-magnetic capstan belt described above is not stored within, for example, a tape cartridge, and is a constituent element of the magnetic tape apparatus. This soft-magnetic capstan belt has a surface contact with the magnetic tape, and presses the tape to the tape head to stabilize the contact between the tape and the head. The soft-magnetic capstan belt further controls stably the running speed of the magnetic tape by carrying the magnetic tape along with itself, and thus prevents the stretch of the magnetic tape over time. Furthermore, the soft-magnetic capstan belt plays the same role as a soft-magnetic under layer (SUL) in hard disks for perpendicular magnetic recording, which contributes to adequately perform perpendicular magnetic recording.

In the magnetic tape apparatus according to the present invention, it is preferable that at least two capstan-belt axes are further provided and the soft-magnetic capstan belt is a loop running among the at least two capstan-belt axes. Further in the case, it is also preferable that the soft-magnetic capstan belt comprises a plurality of through holes and at least one of the at least two capstan-belt axes comprises at least one pin that can be fit into the through hole for preventing the soft-magnetic capstan belt from slipping. Providing the through holes (perforation) and the pins enables the soft-magnetic capstan belt to be prevented from slipping from the capstan-belt axis. As a result, the rotational motion of a driving motor is directly transmitted to the soft-magnetic capstan belt, and thus, the running speed of the magnetic tape, which runs together with the soft-magnetic capstan belt, can be more stabilized.

Further, in the magnetic tape apparatus according to the present invention, the tape head is preferably a rotary head that can rotate. In this case, it is further preferable that: at least during recording, two capstan-belt axes are positioned, so as to interpose the tape head between the two capstan-belt axes, and on a rear side of an end surface of the tape head, the end surface being opposed to the magnetic tape, when viewed from a side of reels for the magnetic tape; and one capstan-belt axis is positioned closer to the reels for the magnetic tape than the tape head in order to bring about tensile stress in the soft-magnetic capstan belt.

Further, in the magnetic tape apparatus according to the present invention, the write head element for perpendicular magnetic recording preferably comprises: a main magnetic pole layer for generating magnetic flux used during write operation; and a write shield layer for receiving the magnetic flux that is generated from the main magnetic pole layer and returns through the soft-magnetic capstan belt. And the soft-magnetic capstan belt is preferably a ribbon formed of a soft-magnetic metal.

According to the present invention, further provided is a tape cartridge used for the magnetic tape apparatus as described above, which comprises a magnetic tape without a soft-magnetic under layer, the magnetic tape comprising a perpendicular magnetization layer on which record tracks are formed. This tape cartridge can keep sufficiently large recording density per volume in the form of a reel of magnetic tape.

Further objects and advantages of the present invention will be apparent from the following description of preferred embodiments of the invention as illustrated in the accompanying figures. In each figure, the same element as an element shown in other figure is indicated by the same reference numeral. Further, the ratio of dimensions within an element and between elements becomes arbitrary for viewability.

### BRIEF DESCRIPTION OF THE SEVERAL VIEWS OF THE DRAWINGS

FIGS. 1a to 1d show schematic views illustrating the configuration of an embodiment of magnetic tape apparatus according to the present invention;

FIGS. 1e and 1f show top views illustrating another embodiment concerning the configuration of capstan-belt axes;

FIG. 2 shows a perspective view schematically illustrating the configuration around the capstan-belt axis;

FIG. 3 shows a perspective view schematically illustrating the head part provided in the rotary head;

FIG. 4 shows a cross-sectional view taken along plane A in FIG. 3, schematically illustrating the structure of the head part;

FIG. 5 shows a cross-sectional view corresponding to the cross-section taken along plane A in FIG. 3, for explaining the principle in which perpendicular magnetic recording can be performed adequately by using the soft-magnetic capstan belt according to the present invention.

### DETAILED DESCRIPTION OF THE INVENTION

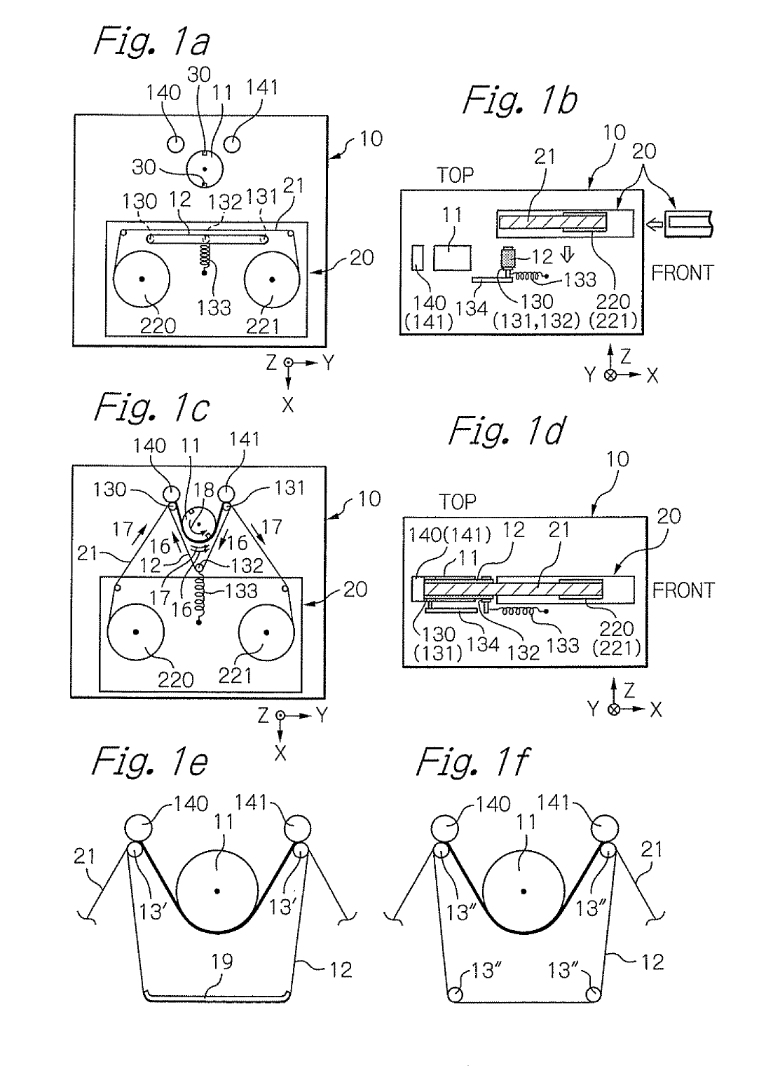

FIGS. 1a to 1d show schematic views illustrating the configuration of an embodiment of magnetic tape apparatus 10 according to the present invention. Here, FIGS. 1a and 1b show the state just after inserting a tape cartridge 20 into the magnetic tape apparatus 10, and are a top view and a side view, respectively. While, FIGS. 1c and 1d show the state when just completing the loading of the tape cartridge 20 into the magnetic tape apparatus 10, and are also a top view and a side view, respectively. Further, FIGS. 1e and 1f show top views illustrating another embodiment concerning the configuration of capstan-belt axes.

As shown in FIGS. 1a and 1b, the magnetic tape apparatus 10 includes: a rotary head 11 as a tape head for perpendicular magnetic recording; three capstan-belt axes 130, 131 and 132; a soft-magnetic capstan belt 12 that is a loop running among these capstan-belt axes; and two pinch rollers 140 and 141 formed of, for example, a rubber. The tape cartridge 20, which is inserted in the figures, includes: a magnetic tape 21 as a magnetic recording medium with a perpendicular magnetization layer; and two reels 220 and 221 for winding and unwinding (feeding) the magnetic tape 21. The magnetic tape apparatus 10 further includes a recording/reproducing control circuit for controlling read and/or write operations of the rotary head 11, though not shown in the figures.

The rotary head 11 includes one or more head part 30 (two head parts in the present embodiment), and corresponds to helical-scanning method in the present embodiment; that is, the rotary head 11 is contacted with the magnetic tape 21 and rotates obliquely to read and write data. The peripheral velocity in rotation of the rotary head 11 is set to be sufficiently larger than the running speed of the magnetic tape 21. The head part 30 includes: an electromagnetic transducer for writing data to the magnetic tape 21 by using perpendicular magnetic recording method; and a magnetoresistive (MR) element for reading data from the magnetic tape 21, as detailed later. In the helical-scanning method, the record tracks formed by the electromagnetic transducer extends, on the magnetization layer in the magnetic tape, obliquely to the direction in which the tape runs. Tape heads for perpendicular magnetic recording used in the magnetic tape apparatus 10 according to the present invention are not limited to the above-described rotary head 11; that is, a linear head can also be used, which has electromagnetic transducer(s) for perpendicular magnetic recording.

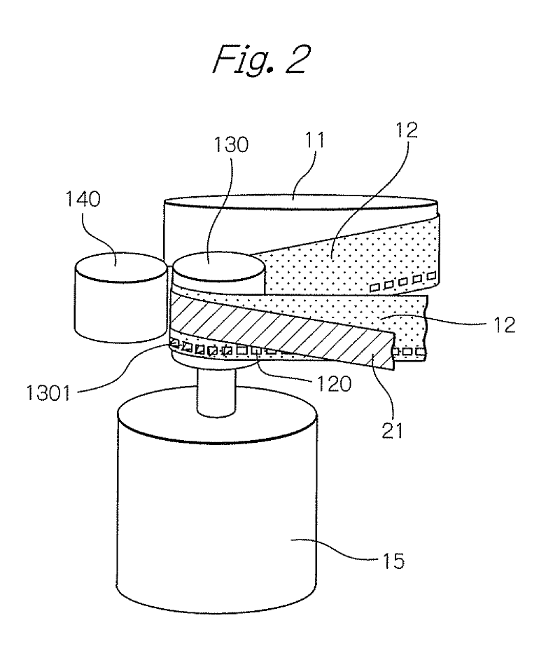

As detailed later, the soft-magnetic capstan belt 12 has a surface contact with the magnetic tape 21, and presses the tape 21 to the rotary head 11 to stabilize the contact between the tape 21 and the head 11. The soft-magnetic capstan belt 12 further controls stably the running speed of the magnetic tape 21 by carrying the magnetic tape 21 along with itself, and thus prevents the stretch of the magnetic tape 21 over time. Furthermore, the soft-magnetic capstan belt 12 plays the same role as a soft-magnetic under layer (SUL) in a hard disk for perpendicular magnetic recording. The soft-magnetic capstan belt 12 is required to have much higher tensile strength than the magnetic tape 21, and may be a metal ribbon formed of a soft-magnetic material such as, for example, NiFe (Permalloy) or FeCoMnCrSiB in which Cr (chromium), Si (silicon) and B (boron) are added in FeCoMn. The width of the soft-magnetic capstan belt 12 is preferably the same as, or larger than the width of the magnetic tape 21 in order to provide perforation 120 (FIG. 2) described later; thus the width of the soft-magnetic capstan belt 12 could be set to be, for example, approximately 22 mm (millimeters) in the case that the magnetic tape 21 has a width of 12.65 mm.

Here, the loading of the tape cartridge 20 will be explained. First, the tape cartridge 20 is moved in the lower (−Z) direction by a loading mechanism (not shown in the figure) from the state as shown in FIGS. 1a and 1b, in which the tape cartridge 20 has just been inserted from the front surface of the magnetic tape apparatus 10. Thus, the capstan-belt axes 130, 131 and 132 and the soft-magnetic capstan belt 12 are inserted within the tape cartridge 20. After that, as the capstan-belt axes 130 and 131 are moved in the —X direction by using an arm 134, the magnetic tape 21 is directly pressed by the soft-magnetic capstan belt 12, and is pulled out to the rotary head 11. The arm 134 is moved until, as shown in FIGS. 1c and 1d, the capstan-belt axes 130 and the pinch roller 140 pinch the soft-magnetic capstan belt 12 and the magnetic tape 21, and the capstan-belt axes 131 and the pinch roller 141 also do so.

In the state of completing the loading as shown in FIGS. 1c and 1d, that is, in the state of enabling the recording and reproducing, two capstan-belt axes 130 and 131 are positioned, so as to interpose the rotary head 11 between themselves, and on the rear side (in the —X direction) of the curved end surface of the rotary head 11, the curved end surface being opposed and contacted with the magnetic tape 21, when viewed from the reels 220 and 221 side (from the side of the front surface of magnetic tape apparatus 10). As a result, the soft-magnetic capstan belt 12 contacts and presses the magnetic tape 21 to a part of the curved end surface of the rotary head 11. Further, the capstan-belt axis 132 is positioned closer to the reels 220 and 221 than the rotary head 11 in the direction along the X-axis, in order to bring about tensile stress in the soft-magnetic capstan belt 12. The soft-magnetic capstan belt 12 receives a sufficiently large amount of tensile force from the capstan-belt axis 132 due to a spring 133 attached to the capstan-belt axis 132. Therefore, the soft-magnetic capstan belt 12 presses the magnetic tape 21 to the rotary head 11 with a sufficiently large amount of press force. Conventionally, the well-known capstan method is used for contacting the magnetic tape with the rotary head, in which the pressing load of the magnetic tape to the rotary head depends on the tensile force that the capstan provides to the magnetic tape. On the contrary, the present invention uses the soft-magnetic capstan belt 12 as described above, which enables the magnetic tape 21 and the rotary head 11 to be contacted with each other more stably compared to the conventional method.

During recording and reproducing, the soft-magnetic capstan belt 12 has a surface contact with the magnetic tape 21 and runs together with the tape 21 in an integrated manner by a sufficiently large amount of static frictional force, in the range at least from the capstan-belt axis 130 (the pinch roller 140) to the capstan-belt axis 131 (the pinch roller 141) through the surface of the rotary head 11. Here, in FIG. 1c, an arrow 16 indicates the running direction of the soft-magnetic capstan belt 12, an arrow 17 indicates the running direction of the magnetic tape 21, and an arrow 18 indicates the rotation direction of the rotary head 11. Thus, the soft-magnetic capstan belt 12 acts as a tape feed mechanism, and the running of the magnetic tape 21 is brought about by the whole portion of the tape 21 having a surface contact with the soft-magnetic capstan belt 12 that is running. As a result, the running speed of the magnetic tape 21 coincides with that of the soft-magnetic capstan belt 12. Conventionally, the magnetic tape runs only by the force transmitted from the rotation of the capstan at the position of the capstan. On the contrary, in the present invention, the soft-magnetic capstan belt 12 has a surface contact with the magnetic tape 21, and they both run together at the same running speed, which enables the running speed of the magnetic tape 21 to be controlled more stably compared to the conventional.

Further, especially even in the position of the rotary head 11 in which large frictional force works to disturb the running of the magnetic tape 21, the soft-magnetic capstan belt 12 and the magnetic tape 21 run together in an integrated manner. Therefore, the external force working to the magnetic tape 21 becomes mainly shear stress between the front and back surfaces; that is, the force pulling the magnetic tape 21 becomes smaller. Whereas, even in the conventional case of using the configuration with a main tape and an auxiliary tape disclosed in Japanese Patent Publication No. 63-122001A as described above, the auxiliary tape is likely to stretch over time more than the soft-magnetic capstan belt 12; that is, the configuration could not effect the suppression of the tape stretch over time. On the contrary, in the present invention, the stretch of the magnetic tape 21 can be suppressed more sufficiently compared to the conventional, which enables the magnetic tape 21 to maintain life sufficiently.

Further, in Japanese Patent Publication No. 63-122001A, the auxiliary tape, as well as the main tape, is wound around reels, and in the case using a tape cartridge, both tapes must be stored within the tape cartridge. Therefore, it is significantly difficult to provide an SUL with a sufficiently large thickness in the auxiliary tape. On the contrary, in the present invention, only the magnetic tape 21 is stored within the tape cartridge 20, and the soft-magnetic capstan belt 12 is a constituent element of the magnetic tape apparatus 20. Therefore, under the condition of keeping sufficiently large recording density per volume in the form of a reel of magnetic tape 21, the soft-magnetic capstan belt 12 with a significantly large thickness can be provided in the tape cartridge 10.

In the magnetic tape apparatus 10 according to the present invention, the number of capstan-belt axes and the number of pinch rollers are not limited to those described above. Especially, the number of capstan-belt axes may be, for example, two as shown in FIG. 1e (reference numeral 13′). In FIG. 1e, a guide plate 19 is provided to guide the soft-magnetic capstan belt 12. Further, as shown in FIG. 1f, four or more capstan-belt axes 13″ are provided to control the tensile stress in the soft-magnetic capstan belt 12 and the running condition of the belt 12 into desired ones. Furthermore, a design with no pinch rollers may be possible.

FIG. 2 shows a perspective view schematically illustrating the configuration around the capstan-belt axis 130.

As shown in FIG. 2, the soft-magnetic capstan belt 12 and the magnetic tape 21 are pinched by the capstan-belt axis 130 and the pinch roller 140, and run together in an integrated manner even on the rotary head 11. Here, the soft-magnetic capstan belt 12 has a plurality of through holes (perforation) 120, and the capstan-belt axis 130 has a plurality of pins 1301 each of which can be fit into the through hole (into the perforation 120). A single pin may be possible, though a plurality of pins 1301 is preferable. Providing the perforation 120 and the pins 1301 enables the soft-magnetic capstan belt 12 to be prevented from slipping from the capstan-belt axis 130. As a result, the rotational motion of a capstan motor 15 is directly transmitted to the soft-magnetic capstan belt 12, and thus, the running speed of the magnetic tape 21, which runs together with the soft-magnetic capstan belt 12, can be more stabilized. As described above, providing the perforation 120 and the pins 1301 is preferable; however, no provision of perforation and pins may be possible. That is, it is possible for the soft-magnetic capstan belt 12 to run depending on the static frictional force between the capstan-belt axis 130 and the soft-magnetic capstan belt 12.

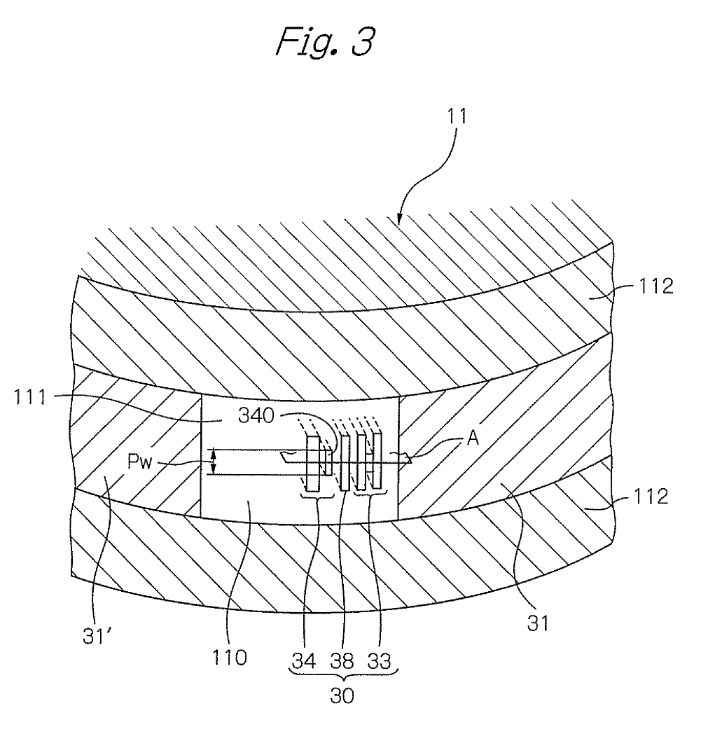

FIG. 3 shows a perspective view schematically illustrating the head part 30 provided in the rotary head 11.

As shown in FIG. 3, the head part 30 includes: an MR element 33 for reading data from the magnetic tape 21; an electromagnetic transducer 34 for writing data to the magnetic tape 21 by using perpendicular magnetic recording method; and an inter-element shield layer 38 for shielding the MR element 33 magnetically from the electromagnetic transducer 34.

A tape bearing surface (TBS) 110 of the rotary head 11 is a curved end surface opposed to the magnetic tape 21. The TBS 110 includes: curved end surfaces of head substrates 31 and 31′; a curved end surface of an insulating member portion 111 surrounding the head part 30; and curved end surfaces of head frames 112.

One ends of MR element 33 and electromagnetic transducer 34 reach the TBS 110 and contact with the magnetic tape 21. That is, the TBS 110 is an opposed-to-medium surface as well as a sliding surface. In this configuration, during read and write operations, the electromagnetic transducer 34 writes data by applying signal magnetic fields to the running magnetic tape 21, and the MR element 33 reads data by sensing signal magnetic fields from the running magnetic tape 21. Here, the width P_{W} of a main magnetic pole layer 340 in the electromagnetic transducer 34 defines the width of the track formed on the perpendicular magnetization layer of the magnetic tape 21 by the write operation.

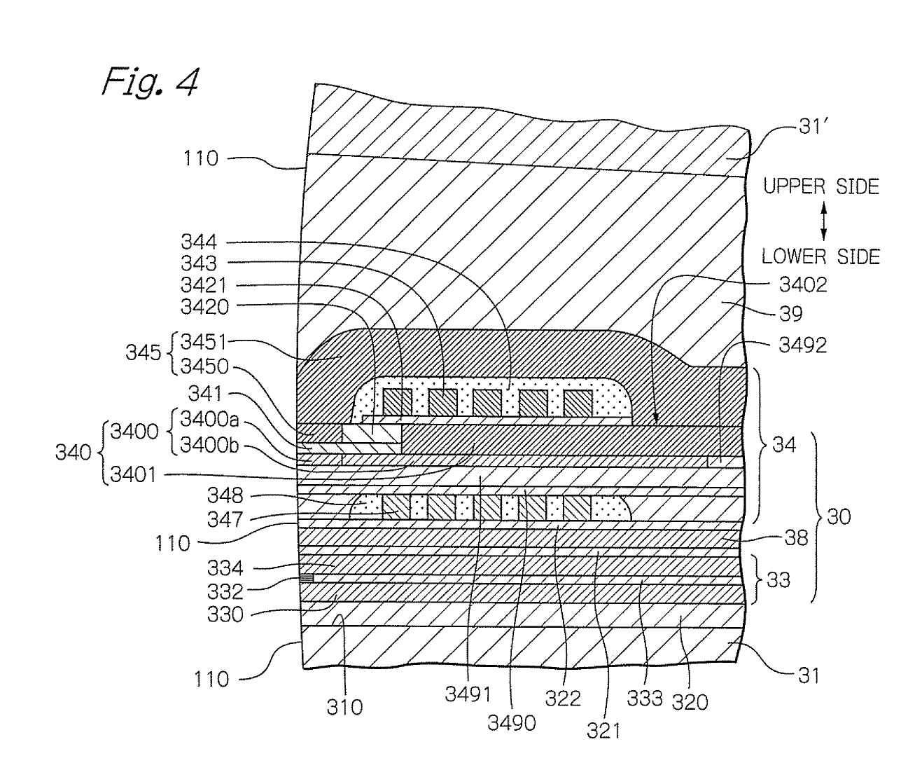

FIG. 4 shows a cross-sectional view taken along plane A in FIG. 3, schematically illustrating the structure of the head part 30.

As shown in FIG. 4, the MR element 33 and electromagnetic transducer 34 are formed on/above an element formation surface 310, which is almost perpendicular to the TBS 110, of the head substrate 31 made of, for example, AlTiC (Al₂O₃—TiC). Further, the head substrate 31′ made of, for example, AlTiC (Al₂O₃—TiC) is adhered on the insulating layer 39 (a part of the insulating member portion 111 shown in FIG. 3) over the formed MR element 33 and electromagnetic transducer 34.

The MR element 33 is formed on an insulating layer 320 (a part of the insulating member portion 111 shown in FIG. 3), and includes: an MR multilayer 332; and a lower shield layer 330 and an upper shield layer 334 which sandwich the MR multilayer 332 and an insulating layer 333 therebetween. The upper and lower shield layers 334 and 330 play a role of preventing the MR multilayer 332 from receiving external magnetic fields that cause noises. The upper and lower shield layers 334 and 330 are, for example, magnetic layers formed by using a frame plating method, a sputtering method or the like, and are made of soft-magnetic material containing, for example, FeSiAl (Sendust), NiFe (Permalloy), CoFeNi, CoFe, FeN, FeZrN or CoZrTaCr, or the multilayer of at least two of these materials, with a thickness of approximately 0.5 to 3 μm.

The MR multilayer 332 is a magneto-sensitive portion for sensing signal magnetic fields by using MR effect, and may be an anisotropic magnetoresistive (AMR) multilayer that utilizes AMR effect, a giant magnetoresistive (GMR) multilayer that utilizes GMR effect, or a tunnel magnetoresistive (TMR) multilayer that utilizes TMR effect. Further, in the case of GMR multilayer, it may be a current-in-plane (CIP) GMR multilayer or a current-perpendicular-to-plane (CPP) GMR multilayer. The MR multilayer 332, which utilizes any of these MR effects, senses signal magnetic fields from the magnetic tape 21 with high sensitivity. In the case that the MR multilayer 332 is a CPP-GMR multilayer or a TMR multilayer, the upper and lower shield layers 334 and 330 also act as electrodes. Whereas, In the case of an AMR multilayer or a CIP-GMR multilayer, a shield layer is provided between the MR multilayer 332 and each of the upper and lower shield layers 334 and 330, and further, formed are MR lead layers that are electrically connected with the MR multilayer 332.

Also as shown in FIG. 4, the electromagnetic transducer 34 is designed for perpendicular magnetic recording in the present embodiment, and includes: a backing coil layer 347, a main magnetic pole layer 340; a gap layer 341; a write coil layer 343; and a write shield layer 345.

The main magnetic pole layer 340 is provided on an insulating layer 3491 formed of an insulating material such as Al₂O₃ (alumina), and acts as a magnetic path for converging and guiding magnetic flux, which is excited by a write current flowing through the write coil layer 343, toward the perpendicular magnetization layer to be written of the magnetic tape 21. The main magnetic pole layer 340 has a double-layered structure in which a main magnetic pole 3400 and a main pole body 3401 are stacked sequentially and magnetically connected with each other. The main magnetic pole 3400 is isolated by being surrounded with an insulating layer 3491 formed of insulating material such as Al₂O₃. The main magnetic pole 3400 reaches the TBS 110, and has: a main pole front end 3400a with a very small width P_{W} (FIG. 3) in the track width direction; and a main pole rear end 3400b located at the rear of the main pole front end 3400a and having a width in the track width direction larger than that of the main pole front end 3400a. Here, the very small width P_{W} of the main pole front end 3400a determines the width of the track formed on the perpendicular magnetization layer of the magnetic tape 21. The width P_{W} is, for example, in the range of approximately 1 to 5 μm. Thus, the very small width P_{W} of the main pole front end 3400a enables a fine write field to be generated, so that the track width can be set to be a very small value adequate for higher recording density.

The main magnetic pole 3400 is formed of a soft-magnetic material with saturation magnetic flux density higher than that of the main pole body 3401, which is, for example, an iron (Fe) alloy with Fe as a main component, such as FeNi, FeCo, FeCoNi, FeN or FeZrN. The thickness of the main magnetic pole 3400 is, for example, in the range of approximately 1 to 5 μm.

The gap layer 341 acts as a gap provided for magnetically separating the main magnetic pole layer 340 from the write shield layer 345 in the region near the head end surface. The gap layer 341 is formed, for example, of a non-magnetic insulating material such as Al₂O₃ (alumina), SiO₂ (silicon dioxide), AlN (aluminum nitride) or DLC, or of a non-magnetic conductive material such as Ru (ruthenium). The thickness of the gap layer 341 determines the amount of gap between the main magnetic pole layer 340 and the write shield layer 345, which is important for controlling write characteristics; and is, for example, in the range of approximately 0.1 to 0.5 μm.

The write coil layer 343 is formed, on a insulating layer 3421 made of an insulating material such as Al₂O₃ (alumina), so as to pass through in one turn at least between the main magnetic pole layer 340 and the write shield layer 345, and has a spiral structure with a back contact portion 3402 as a center. The write coil layer 343 is formed of a conductive material such as Cu (copper). The write coil layer 343 is covered with a write coil insulating layer 344 that is formed of an insulating material such as a heat-cured photoresist; that is, the write coil insulating layer 344 electrically isolates the write coil layer 343 from the main magnetic pole layer 340 and the write shield layer 345.

The write coil layer 343 has a monolayer structure in the present embodiment, however, may have a two or more layered structure or a helical coil shape. Further, the number of turns of the write coil layer 343 is not limited to that shown in FIG. 4, and may be, for example, in the range from two to seven.

The write shield layer 345 includes: a first write shield portion 3450 that reaches the TBS 110 and is provided for receiving the magnetic flux spreading from the main magnetic pole layer 340; and a second write shield portion 3451 that also reaches the TBS 110, and is magnetically connected with the first write shield portion 3450, and acts as a magnetic path for the magnetic flux that returns from the soft-magnetic capstan belt 12 as detailed later, as well as for the magnetic flux that the first write shield portion 3450 receives. The write shield layer 345 is formed of a soft-magnetic material, and especially, the first write shield portion 3450 is formed of a material with high saturation magnetic flux density, such as NiFe (Permalloy) or an iron alloy as the main magnetic pole 3400 is formed of. The thickness of the first write shield portion 3450 is, for example, in the range of approximately 2 to 6 μm. The thickness of the second write shield portion 3451 is, for example, in the range of approximately 2 to 6 μm.

The first write shield portion 3450 according to the present invention is planarized together with an insulating layer 3420 and the main pole body 3401, and has a width in the track width direction larger than the width of the main pole rear end 3400b and the main pole body 3401 as well as the main pole front end 3400a. This write shield portion 3450 can cause the magnetic field gradient between the end portion of the write shield portion 3450 and the main pole front end 3400a to be steeper. As a result, jitter of signal output becomes smaller, and therefore, an error rate during read operation can be reduced.

The backing coil layer 347 is a coil for negating a magnetic flux loop, which is derived from write current applied to the write coil layer 343 of the electromagnetic transducer 34 and passes through the upper and lower shield layers 334 and 330 of the MR element 33. That is, the backing coil layer 347 is provided for suppressing unwanted writing or erasing operation by generating magnetic flux to negate the above-described magnetic flux loop. The backing coil layer 347 has a spiral structure with a back contact portion 3402 as a center, and is electrically isolated by the surrounding coil insulating layer 348 and the insulating layers 322 and 3490, and may be set so that write current flows in the direction opposite to the direction of write current flowing in the write coil layer 343. The backing coil layer 347 has a monolayer structure in the present embodiment, however, may have a two or more layered structure or a helical coil shape. Further, the number of turns of the backing coil layer 347 is not limited to that shown in FIG. 4, and is preferably set, for example, in the range from two to seven in accordance with the number of turns of the write coil layer 343. It should be noticed that write operation to the perpendicular magnetization layer of the magnetic tape 21 can be performed without the backing coil layer 347; that is, an embodiment without the backing coil layer 347 could be in the scope of the present invention.

Further, in the present embodiment, an inter-element shield layer 38 is provided between the MR element 33 and the electromagnetic transducer 34, sandwiched by the insulating layers 321 and 322. The inter-element shield layer 38 plays a role for shielding the MR element 33 from the magnetic field generated from the electromagnetic transducer 34, and may be formed of the same soft-magnetic material as the upper and lower shield layers 334 and 330. It should be noticed that read and write operations by the head part 30 can be performed without the inter-element shield layer 38; that is, an embodiment without the inter-element shield layer 38 could be in the scope of the present invention.

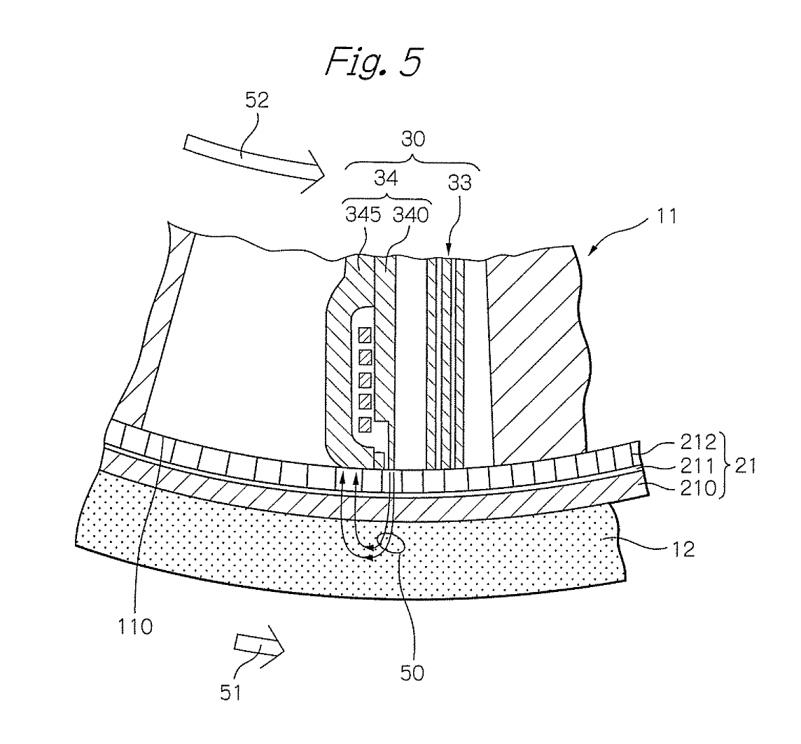

FIG. 5 shows a cross-sectional view corresponding to the cross-section taken along plane A in FIG. 3, for explaining the principle in which perpendicular magnetic recording can be performed adequately by using the soft-magnetic capstan belt 12 according to the present invention.

FIG. 5 indicates the state in which, during write operation by the rotary head 11, the magnetic tape 21 is contacted with the rotary head 11 by being pressed with the soft-magnetic capstan belt 12. An arrow 51 indicates the running direction of the magnetic tape 21 that has a surface contact with the soft-magnetic capstan belt 12 and is driven integrally with the belt 12. And an arrow 52 indicates the rotation direction of the rotary head 11.

As shown in FIG. 5, the magnetic tape 21 includes: a non-magnetic base film 210 formed of, for example, polyester or the like, with thickness of, for example, approximately 5 to 10 μm; a base layer 211; and a perpendicular magnetization layer 212 formed of, for example, CoCr or the like, with thickness of, for example, approximately 50 to 100 nm. The soft-magnetic capstan belt 12 is a metal ribbon formed of a soft-magnetic material such as, for example, NiFe (Permalloy) or FeCoMnCrSiB in which Cr, Si and B are added in FeCoMn, as described above, with thickness of, for example, approximately 10 to 200 μm.

During write operation, magnetic flux 50 corresponding to write field, which is generated from the end on the TBS 110 side of the main magnetic pole layer 340 of the electromagnetic transducer 34, passes through the perpendicular magnetization layer 212 (causes a portion of magnetization of the perpendicular magnetization layer 212 to be turned upward or downward). Then, magnetic flux 50 folds back through the soft-magnetic capstan belt 12, and reaches the write shield layer 345. The magnetic flux, which has reached the write shield layer 345, folds back in the back contact portion 3402, and returns to the main magnetic pole layer 340. In this way, the closed loop of magnetic flux corresponding to write field is completed, which enables perpendicular magnetic recording to be effectively performed. That is to say, the soft-magnetic capstan belt 12 according to the present invention plays the same role as a soft-magnetic under layer (SUL) in hard disks for perpendicular magnetic recording.

Here, considered will be the case in which an SUL is provided within the magnetic tape 21, instead of using the soft-magnetic capstan belt 12. Usually, the thickness of the SUL in the hard disk for perpendicular magnetic recording is, for example, in the range of approximately 30 to 100 nm. However, a tape head generally has a larger size than a thin-film magnetic head for perpendicular magnetic recording. For example, the amount of gap (the thickness of the gap layer) between the main magnetic pole and the auxiliary magnetic pole of the tape head may be ten times or more larger than that of the thin-film magnetic head. Therefore, a significantly large thickness of the SUL in the magnetic tape would be needed according to the difference in scale. However, the significantly large thickness of the SUL would be likely to cause the decrease in recording density per volume in the form of a reel of magnetic tape, the degradation in flexibility of the magnetic tape which would lead an inadequate contact with the head, or the damage such as for the constituent film being peeled from the magnetic tape.

On the contrary, in the case of using the soft-magnetic capstan belt 12 according to the present invention, there is no need to provide such a thick SUL within the magnetic tape 21. Therefore, under the condition of keeping sufficiently large recording density per volume in the form of a reel of magnetic tape 21 in the tape cartridge 20, the soft-magnetic capstan belt 12 with a significantly large thickness can be provided in the magnetic tape apparatus 10, which can realize adequate perpendicular magnetic recording.

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. A magnetic tape apparatus for recording data to a magnetic tape with a perpendicular magnetization layer, comprising:
a tape head comprising at least one write head element for perpendicular magnetic recording; and
a soft-magnetic capstan belt having a surface contact with said magnetic tape and pressing said magnetic tape to said tape head at least during recording, for controlling running speed of said magnetic tape by causing said magnetic tape to run together with said soft-magnetic capstan belt.

2. The magnetic tape apparatus as claimed in claim 1, wherein at least two capstan-belt axes are further provided, and said soft-magnetic capstan belt is a loop running among said at least two capstan-belt axes.

3. The magnetic tape apparatus as claimed in claim 2, wherein said soft-magnetic capstan belt comprises a plurality of through holes, and at least one of said at least two capstan-belt axes comprises at least one pin that can be fit into the through hole for preventing said soft-magnetic capstan belt from slipping.

4. The magnetic tape apparatus as claimed in claim 2, wherein said tape head is a rotary head that can rotate.

5. The magnetic tape apparatus as claimed in claim 4, wherein, at least during recording, two capstan-belt axes are positioned, so as to interpose said tape head between said two capstan-belt axes, and on a rear side of an end surface of said tape head, the end surface being opposed to said magnetic tape, when viewed from a side of reels for said magnetic tape, and one capstan-belt axis is positioned closer to the reels for said magnetic tape than said tape head in order to bring about tensile stress in said soft-magnetic capstan belt.

6. The magnetic tape apparatus as claimed in claim 1, wherein the write head element for perpendicular magnetic recording comprises: a main magnetic pole layer for generating magnetic flux used during write operation; and a write shield layer for receiving the magnetic flux that is generated from said main magnetic pole layer and returns through said soft-magnetic capstan belt.

7. The magnetic tape apparatus as claimed in claim 1, wherein said soft-magnetic capstan belt is a ribbon formed of a soft-magnetic metal.

8. A tape cartridge used for the magnetic tape apparatus as claimed in claim 1, comprising a magnetic tape without a soft-magnetic under layer, said magnetic tape comprising a perpendicular magnetization layer on which record tracks are formed.
